(19) United States
(12) Patent Application Publication
(10) Pub. No.: US 2014/0292616 A1
(43) Pub. Date: Oct. 2, 2014

(54) COMPUTER MONITOR EQUALIZATION USING HANDHELD DEVICE

(71) Applicant: NVIDIA CORPORATION, Santa Clara, CA (US)

(72) Inventors: Andrew Fear, Austin, TX (US); Tom Petersen, Santa Clara, CA (US); Michael McSorley, Santa Clara, CA (US); Gerrit Slavenburg, Santa Clara, CA (US)

(73) Assignee: Nvidia Corporation, Santa Clara, CA (US)

(21) Appl. No.: 13/852,621

(22) Filed: Mar. 28, 2013

(51) Int. Cl. G06F 3/14

(52) U.S. Cl. CPC G06F 3/1423
USPC 345/1.1

(57) ABSTRACT

A computer monitor equalization system includes a computer system having a plurality of monitors and a mobile networking unit that captures display image samples from the plurality of monitors, wherein the display image samples are captured optically for monitor equalization. The computer monitor equalization system also includes an image analyzing unit that analyzes the display image samples to determine a monitor adjustment required to equalize the plurality of monitors. In another aspect, a computer monitor equalization method includes providing a computer system having a plurality of monitors and capturing display image samples from the plurality of monitors, wherein the display image samples are captured optically for monitor equalization employing a mobile network device. The computer monitor equalization method also includes analyzing the display image samples to determine a monitor adjustment required to equalize the plurality of monitors.

### TECHNICAL FIELD

This application is directed, in general, to a computer system and, more specifically, to a computer monitor equalization system and a computer monitor equalization method.

### BACKGROUND

Many computer systems employ more than one monitor for display purposes. Multiple monitors may be used to improve workflow or enhance recreational pursuits such as video gaming. When using multiple monitor computer systems, users may encounter monitors having display characteristics, such as color or brightness, which are significantly different. This can result for monitors from different manufacturers, or commonly manufactured monitors that use different display panel venders. Even different manufacturing runs from the same manufacturer for a given monitor model may provide different display characteristics. Additionally, monitor calibration techniques require expensive calibration tools that need to be applied separately or manually to each monitor. An improved display adjustment technique for monitors would be beneficial to the art.

### SUMMARY

Embodiments of the present disclosure provide a computer monitor equalization system and a computer monitor equalization method.

In one embodiment, the computer monitor equalization system includes a computer system having a plurality of monitors and a mobile networking unit that captures display image samples from the plurality of monitors, wherein the display image samples are captured optically for monitor equalization. The computer monitor equalization system also includes an image analyzing unit that analyzes the display image samples to determine a monitor adjustment required to equalize the plurality of monitors.

In another aspect, the computer monitor equalization method includes providing a computer system having a plurality of monitors and capturing display image samples from the plurality of monitors, wherein the display image samples are captured optically for monitor equalization employing a mobile network device. The computer monitor equalization method also includes analyzing the display image samples to determine a monitor adjustment required to equalize the plurality of monitors.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

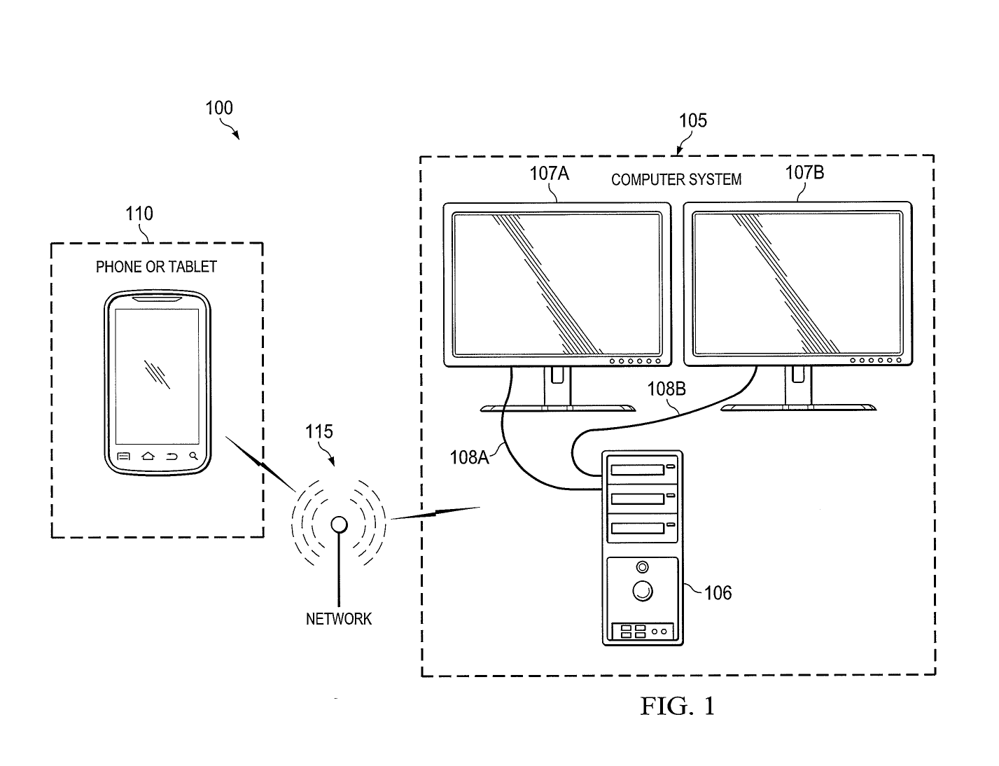

FIG. 1 illustrates a diagram of an embodiment of a computer monitor equalization system constructed according to the principles of the present disclosure;

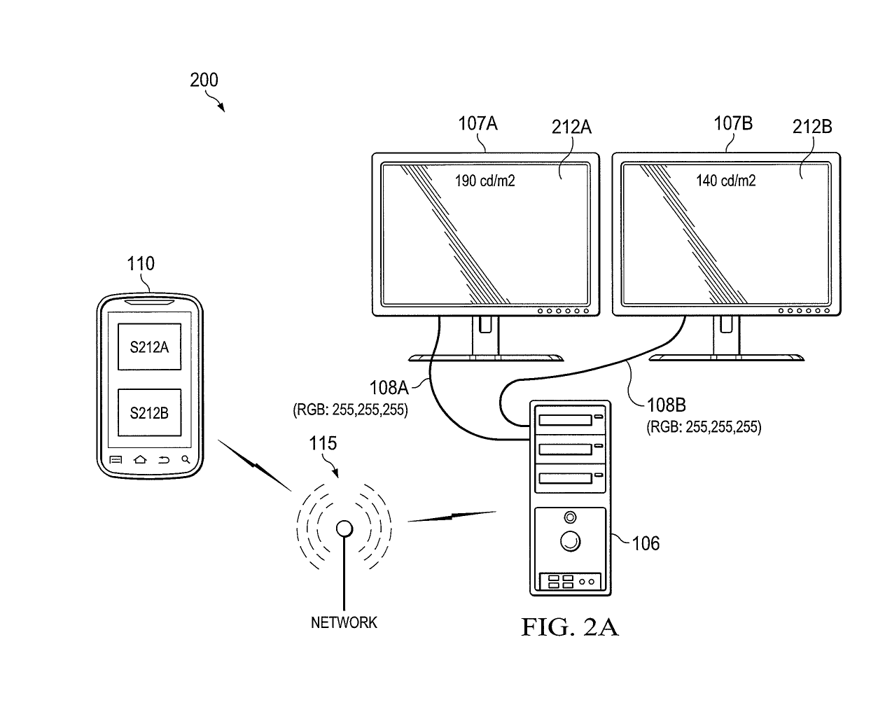

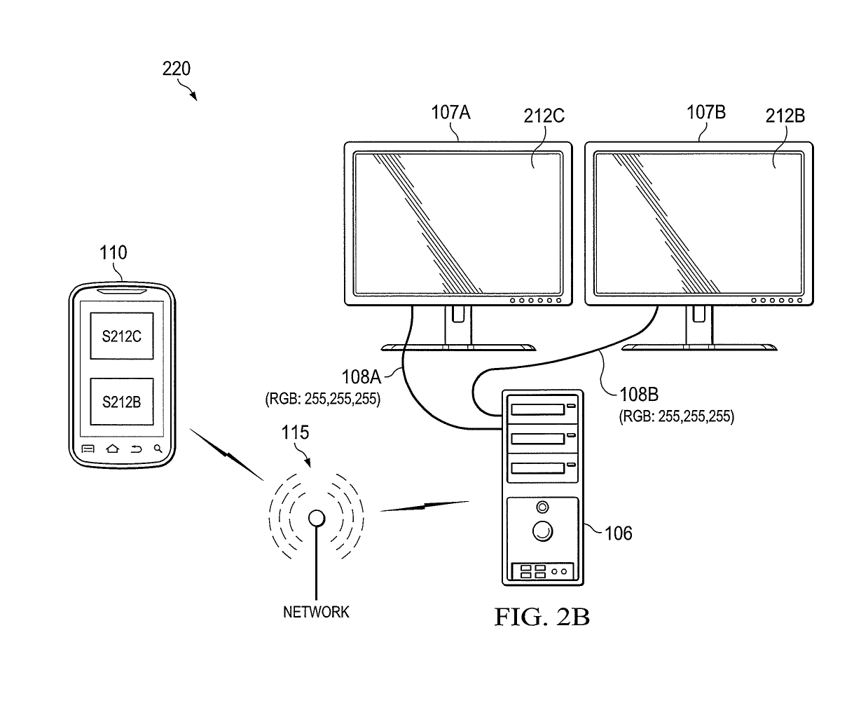

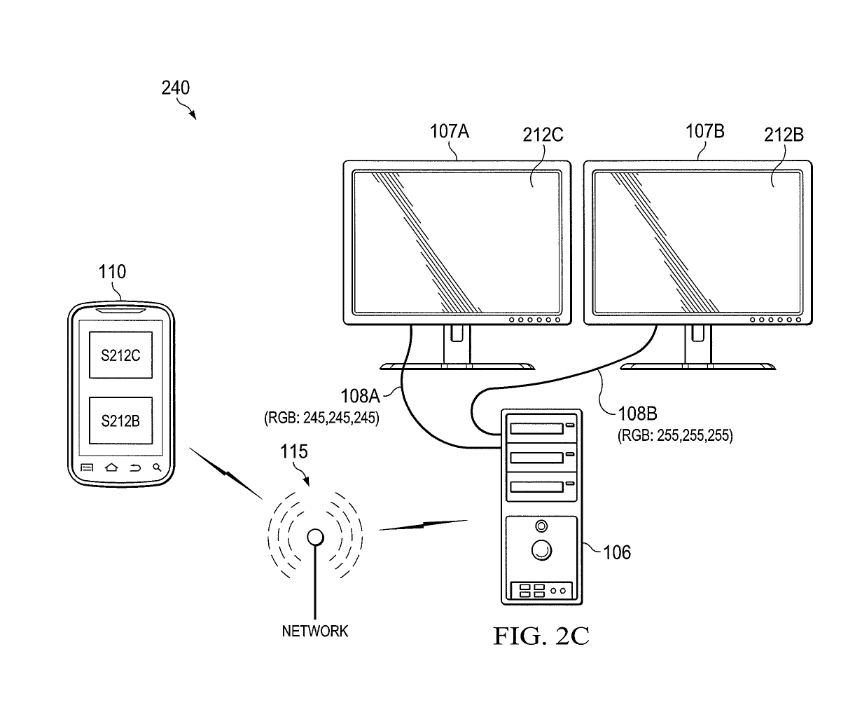

FIGS. 2A, 2B and 2C illustrate brightness equalization arrangements for the computer monitor equalization system of FIG. 1;

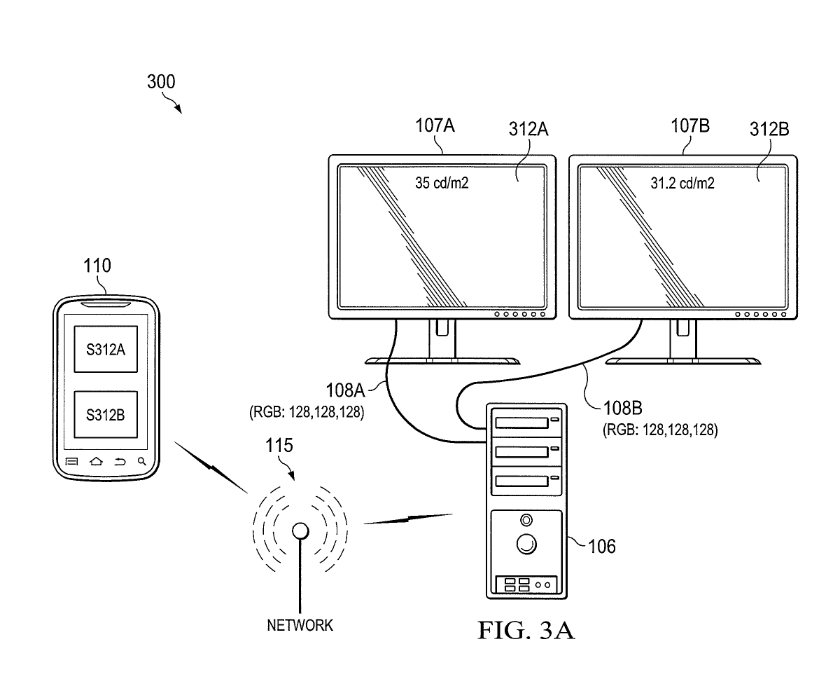

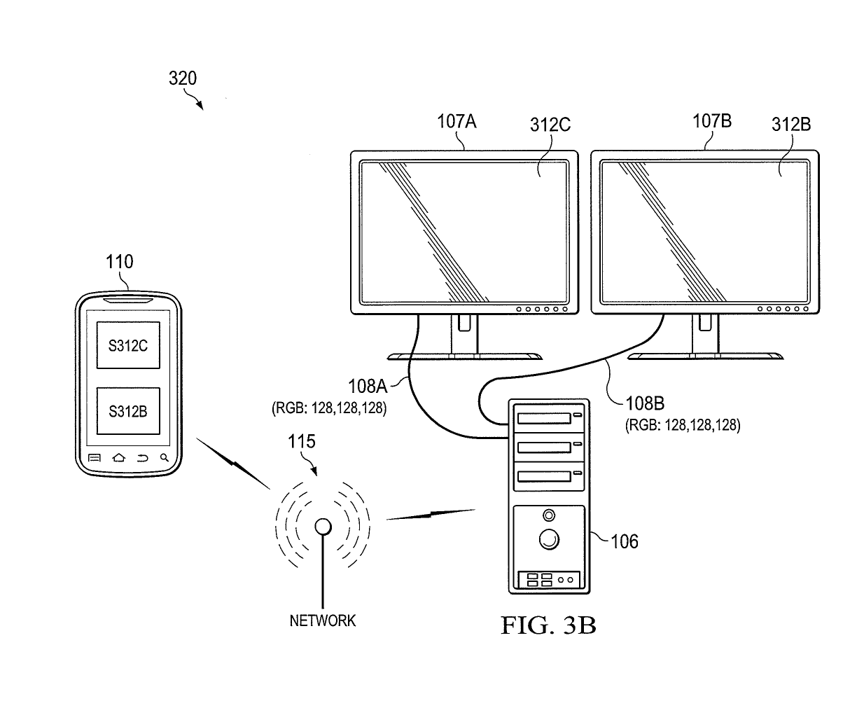

FIGS. 3A and 3B illustrate gamma equalization arrangements for the computer monitor equalization system of FIG. 1;

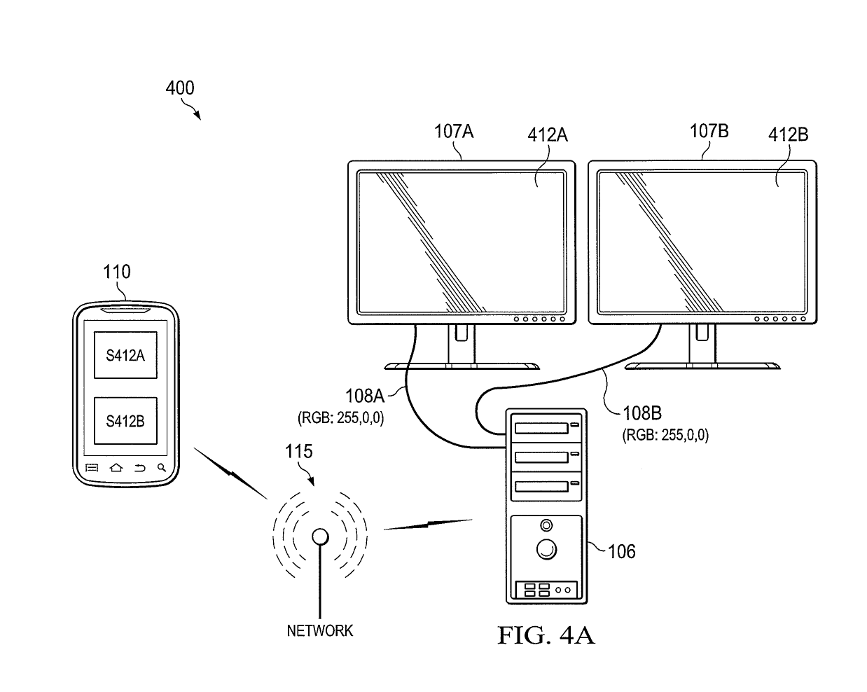

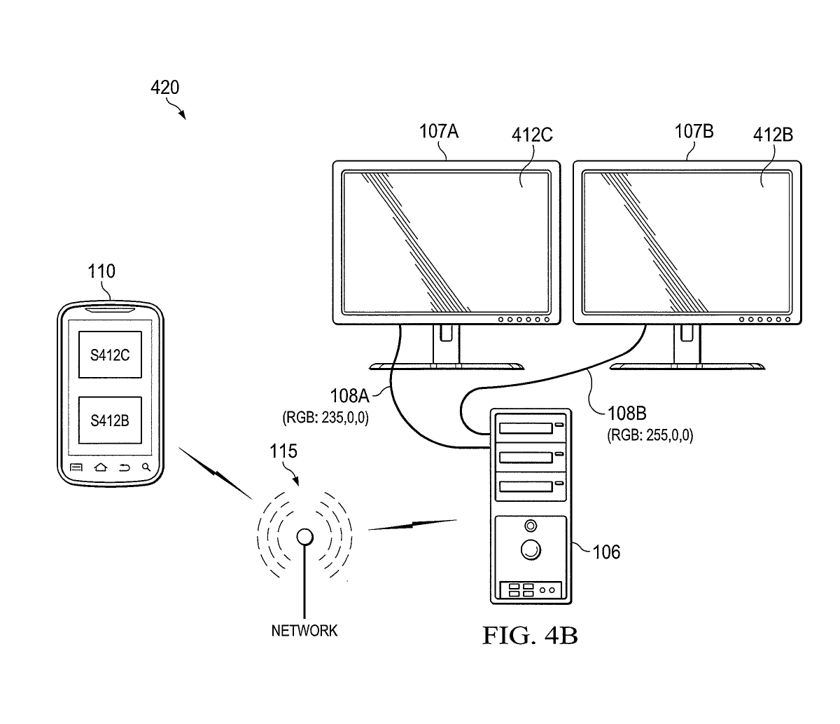

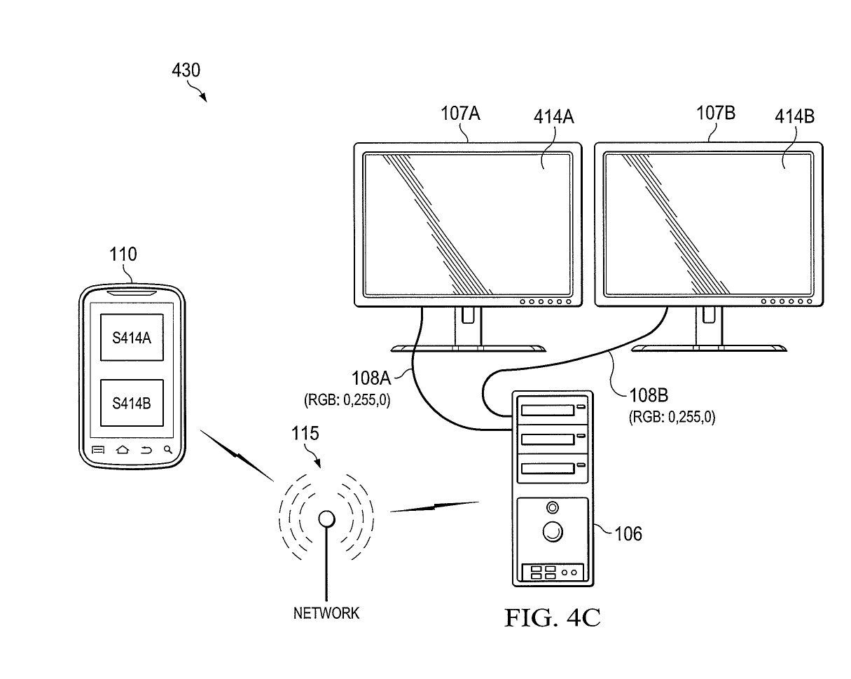

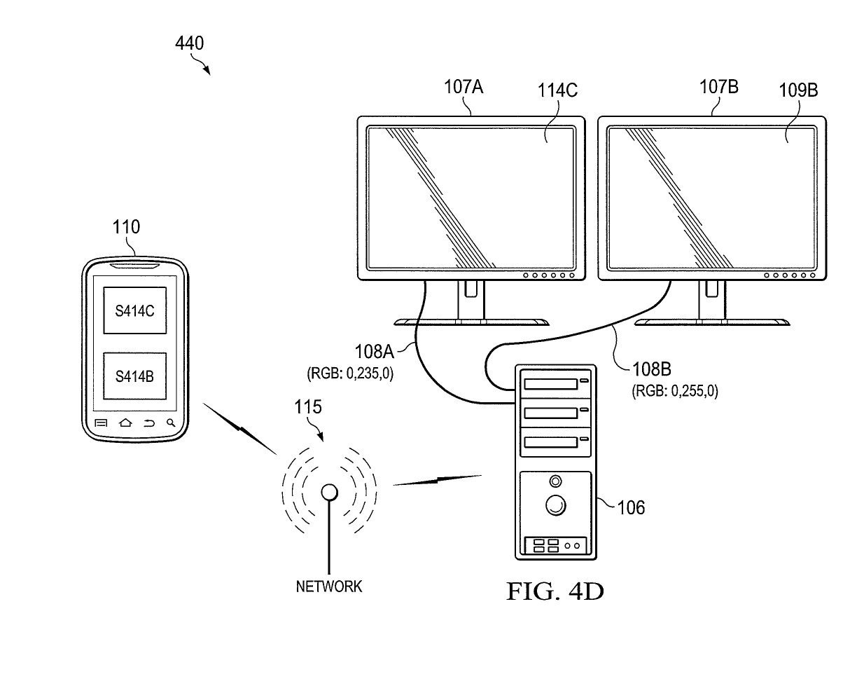

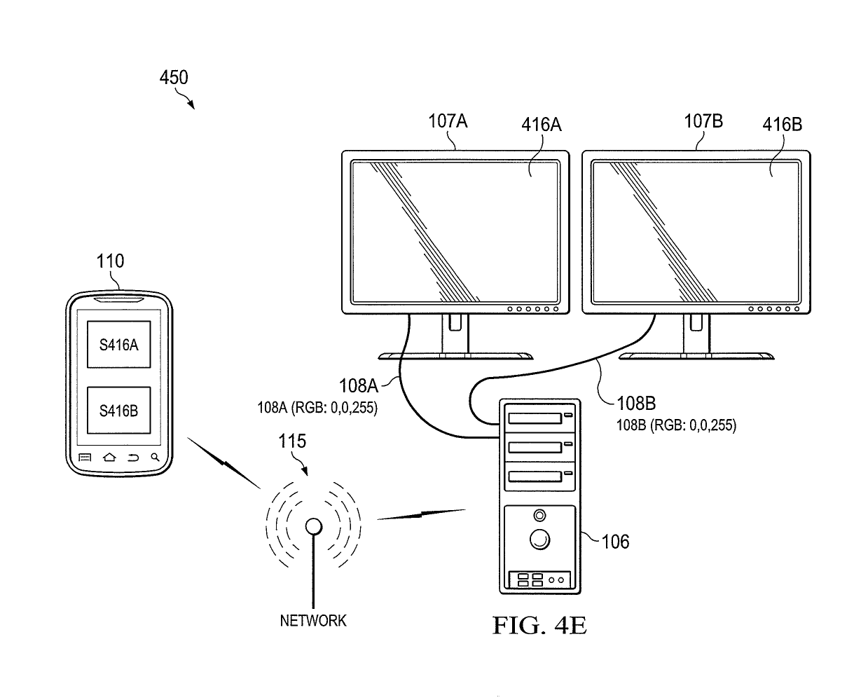

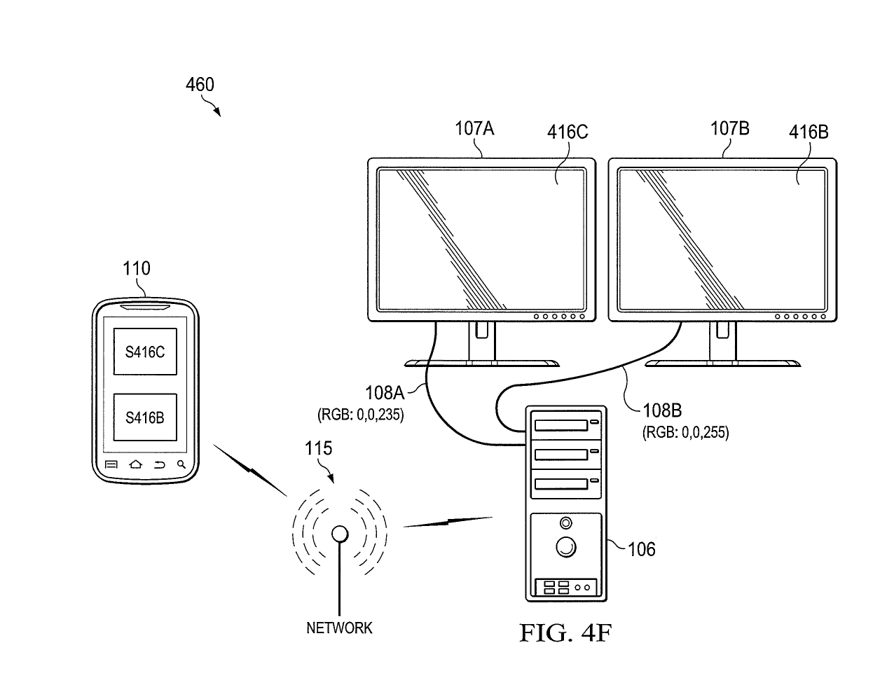

FIGS. 4A through 4F illustrate color equalization arrangements for the computer monitor equalization system of FIG. 1; and

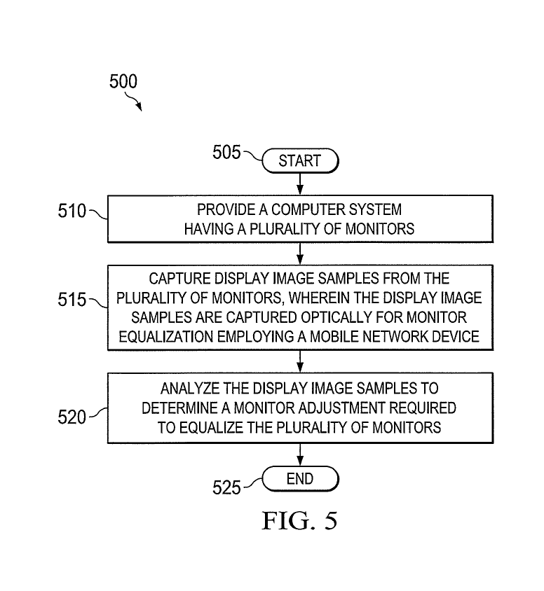

FIG. 5 illustrates a flow diagram of an embodiment of a computer monitor equalization method carried out according to the principles of the present disclosure.

### DETAILED DESCRIPTION

FIG. 1 illustrates a diagram of an embodiment of a computer monitor equalization system, generally designated 100, constructed according to the principles of the present disclosure. The computer monitor equalization system 100 includes a computer system 105, a handheld device 110 and a communications network 115.

The computer system 105 includes a general purpose computer 106 having a graphics processing unit (GPU) that supports first and second monitors 107A, 107B over respective first and second monitor control cables 108A, 108B, which additionally provide test image commands and monitor adjustments. The handheld device 110, which is generally representative of a mobile networking unit, is a mobile (cell) phone in the illustrated embodiment and may be a computer tablet or a standalone digital camera in other embodiments, for example. The communications network 115 is representative of a general purpose network that allows communication between the general purpose computer 106 and the handheld device 110 as well as data transfer and analysis. The general purpose network may include a WiFi system, an Internet system or a cloud system, for example.

Generally, the handheld device 110 employs an image capturing unit that captures display image samples from the first and second monitors 107A, 107B. In this particular embodiment, the mobile phone is a smart phone that employs its associated camera as the image capturing unit. In some embodiments, the handheld device 110 includes an image analyzing unit that analyzes the display image samples to determine a monitor adjustment required to equalize the first and second monitors 107A, 107B.

In other embodiments, the image analyzing unit may be contained in the general purpose computer 106 and data corresponding to the display image samples obtained by the handheld device 110 are conveyed through the communications network 115 to the general purpose computer 106 for analysis. In yet other embodiments, the image analyzing unit is contained in an Internet server or a cloud server and data corresponding to the display image samples obtained by the handheld device 110 are conveyed for analysis to these servers through the communications network 115. In still other embodiments, analysis of the display image samples may employ a combination of the above.

Equalization of the first and second monitors 107A, 107B may be initiated through equalization instructions (e.g., a set-up wizard) provided on one of the first and second monitors 107A, 107B or on the handheld device 110. These equalization instructions can provide tips on using the smart phone's imaging system to capture the display image samples for analysis as well as actual steps to follow for the equalization process. Equalization of a plurality of monitors typically includes adjustments to the monitors in the three areas of brightness, gamma and color.

FIGS. 2A, 2B, 2C illustrate brightness equalization arrangements, generally designated 200, 220, and 240 for the computer monitor equalization system of FIG. 1. The brightness equalization arrangements 200, 220, 240 include the computer system 105, the handheld device 110 and the communications network 115, as before. Here, it is recognized that contrast is a difference between monitor white and black. One cannot affect the blackness of a monitor, but the whiteness of the monitor can be equalized, and this adjustment is called brightness or luminance balancing.

In FIG. 2A, the first and second monitor control cables 108A, 108B provide the same first and second test image commands (RGB: 255,255,255) calling for a maximum brightness from each of the first and second monitors 107A, 107B. The first monitor 107A is responding with a first display image 212A having a brightness of 190 cd/m2 that is brighter than a second display image 212B having a brightness of 140 cd/m2 for the second monitor 107B, in this example.

The handheld device 110 employs its camera to capture first and second display image samples S212A, S212B at the same time, as shown on the handheld device 110. The first and second display image samples S212A, S212B are analyzed for relative brightness employing one or more image analyzing techniques previously discussed. Here, it is found that the second monitor 107B is less bright than the first monitor 107A by a ratio of 140/190. Two approaches to brightness balancing are discussed below. In FIG. 2B, brightness balancing is provided by employing a VCP command over DDC/CI to the first monitor 107A. In FIG. 2C, brightness balancing is provided by the GPU adjusting its output, for example by changing its gain value for the first monitor 107A.

In FIG. 2B, the general purpose computer 106 issues a VCP command over DDC/CI across the first monitor control cable 108A to the first monitor 107A to reduce its brightness by some amount, (e.g., say 20 percent). The first monitor 107A has its brightness reduced wherein the first and second monitor control cables 108A, 108B continue to provide both monitors with the same first and second test image commands (RGB: 255,255,255). This results in an updated first display image 212C that should more closely match the second display image 212B in the brightness balancing process.

The handheld device 110 again employs its camera to capture the updated first display image sample S212C and second display image sample S212B at the same time, as shown on the handheld device 110. These first and second display image samples S212C, S212B are analyzed for relative brightness employing one or more image analyzing unit techniques previously discussed. Here, the image analysis may indicate that the current brightness adjustment is correct, or that the previous brightness adjustment was too small or too large. If the brightness adjustment represented in FIG. 2B is correct, the brightness balancing process is complete.

If the brightness adjustment was not close enough, a second DDC/CI command representing the recent analysis is sent to adjust the brightness of the first monitor 107A in an indicated correct direction while maintaining both the first and second test image commands (RGB: 255,255,255), as before. This brightness balancing process is repeated until the brightness equalization of the first and second monitors 107A and 107B is satisfactory. Once the brightness balancing process is complete, the computer system 105 retains the established brightness balancing parameters for future application.

Alternately, in FIG. 2C, the general purpose computer 106 changes its internal GPU gain to attempt to equalize brightness of the first and second monitors 107A, 107B. This results in the first monitor control cable 108A providing an adjusted first test image command (RGB: 245,245,245) to the first monitor 107A while maintaining the second test image command (RGB: 255,255,255) to the second monitor 107B, as shown.

The handheld device 110 again employs its camera to capture an updated first display image sample S212C and second display image sample S212B at the same time, as shown on the handheld device 110. These first and second display image samples S212C, S212B are analyzed for relative brightness employing one or more image analyzing unit techniques previously discussed. Here, the image analysis may indicate that the current brightness adjustment is correct, or that the current brightness adjustment was too small or too large. If the brightness adjustment represented in FIG. 2C is correct, the brightness balancing process is complete.

If the current brightness adjustment is not close enough, the GPU gain is again adjusted resulting in the first monitor control cable 108A providing another adjusted first test image command (e.g., (RGB: 240,240,240) to provide a reduced brightness) to the first monitor 107A while maintaining the second test image command (RGB: 255,255,255) to the second monitor 107B for further image capturing and image analysis. This brightness balancing process is repeated until the brightness equalization of the first and second monitors 107A and 107B is satisfactory. Once the brightness balancing process is complete, the computer system 105 retains the established brightness balancing parameters for future application.

FIGS. 3A and 3B illustrate gamma equalization arrangements, generally designated 300, 320, for the computer monitor equalization system of FIG. 1. The gamma equalization arrangements 300, 320 include the computer system 105, the handheld device 110 and the communications network 115, as before.

Gamma is the relationship, usually defined by a particular curve, between sending a digital value to a monitor and a brightness or luminance that is displayed on the screen. This follows the particular curve, which is exponential and typically has an exponent of 2.2. Some monitors may have a gamma coefficient of 1.9 to 2.0, and others may have a gamma coefficient of 2.4 to 2.5. This causes visual differences between two monitors as may be seen in the mid-tones of a scene, which may look darker on one monitor when compared to another monitor. Gamma equalization adjustments may be employed to define and compensate for differences in individual monitor gamma curves.

In FIG. 3A, the first and second monitor control cables 108A, 108B provide the same first and second test image commands (RGB: 128,128,128) calling for the same test point luminance (brightness) from each of the first and second monitors 107A, 107B. The first monitor 107A is responding with a first display image 312A having a luminance of 35 cd/m2 that is brighter than a second display image 312B having a luminance of 31.2 cd/m2 for the second monitor 107B, which is the desired value.

The handheld device 110 employs its camera to capture first and second display image samples S312A, S312B at the same time, as shown on the handheld device 110. The first and second display image samples S312A, S312B are analyzed for relative luminance employing one or more image analyzing arrangements as previously discussed. This analysis indicates that the second display image 312B has a relative luminance of 31.2/35 when compared to the first display image 312A.

In FIG. 3B, gamma balancing is provided by employing a VCP command using DDC/CI across the first monitor control cable 108A to the first monitor 107A that increases its gamma and thereby decreases its luminance from a value that originally corresponded to the first test image command (RGB: 128,128,128). The first monitor 107A has its luminance reduced wherein the first and second monitor control cables 108A, 108B continue to provide both monitors with the same first and second test image commands (RGB: 128,128,128). This results in an updated first display image 312C that should more closely match the second display image 312B in the gamma balancing process.

Alternately, the gamma balancing process may be accomplished by employing a gamma look-up table adjustment that is alternately provided from the GPU in the general purpose computer 106. In this case, a modified first test image command (e.g., (RGB: 115,115,115)) may be employed where the second test image command (RGB: 128,128,128) is maintained. In both of these cases, these gamma balancing processes are repeated until the gamma equalization of the first and second monitors 107A and 107B is satisfactory. Once the gamma balancing process is complete, the computer system 105 retains the established gamma balancing parameters for future application.

FIGS. 4A through 4F illustrate color equalization arrangements, generally designated 400, 420, 430, 440, 450, 460, for the computer monitor equalization system of FIG. 1. Again, the color equalization arrangements 400, 420, 430, 440, 450, 460 include the computer system 105, the handheld device 110 and the communications network 115, as before.

Generally, color balancing may be more monitor dependent that brightness or gamma balancing. A preferred approach may be to employ DDC/CI commands to change “Red Gain”, “Blue Gain” and “Green gain”, if such commands are available. If such commands are not available in an employed monitor model, then it may be possible to use “color temperature” DDC/CI commands (e.g., “warm” or “cool”) to change the relative balance of red, green and blue. There may be specialized procedures that correspond to different monitors. Since color calibration is not well standardized in the DDC/CI command set or if a desired monitor lacks the adjustments required, employing or changing the lookup tables in the GPU in the general purpose computer 106 may offer a preferred approach.

In FIG. 4A, the first and second monitor control cables 108A, 108B provide the same first and second test image commands (RGB: 255,0,0) calling for the same red color from each of the first and second monitors 107A, 107B. The first monitor 107A is responding with a first display image 412A that is slightly “brighter red” than a second display image 412B of the second monitor 107B. The handheld device 110 again employs its camera to capture first and second display image samples S412A, S412B at the same time, as shown on the handheld device 110. The first and second display image samples S412A, S412B are analyzed employing one or more image analyzing unit techniques as previously discussed.

In FIG. 4B, the first monitor 107A has its red color adjusted wherein the first monitor control cable 108A provides an updated first test image command (RGB: 235,0,0) resulting in an updated first display image 412C that more closely matches the second display image 412B to establish a first portion of monitor color balancing. This color balancing process may be repeated until color equalization of the first and second monitors 107A and 107B is satisfactory. This is indicated in the handheld device 110 having a new display image sample S412C corresponding to the updated first display image 412C, for further color balancing. Once this color balancing process for the color red is complete, the computer system 105 retains pertinent red color balancing parameters for future application.

In like manner, the color equalization arrangements of FIGS. 4C, 4D for green and FIGS. 4E, 4F for blue employ the first and second monitor control cables 108A, 108B to initially provide first and second test image commands (RGB: 0,255,0) and (RGB: 0,0,255) respectively calling for the same green color or blue color from each of the first and second monitors 107A, 107B. The resulting first and second display images 414A, 414B, and 416A, 416B are sampled (S414A, S414B), (S416A, S416B) and analyzed to establish a relative green color and a relative blue color for the second monitor 107B as compared to the first monitor 107A. In the color equalization arrangements of FIGS. 4D, 4F, the first monitor 107A is updated to closely match the second monitor 107B and the color balancing process may be repeated as required. Of course, the VCP commands to change Red Gain, Blue Gain and Green gain may be employed, if monitor supported. Again, the computer system 105 retains pertinent green and blue color balancing parameters for future application.

Additionally, it may be noted that the color balancing procedure is generally going to reduce red, green, or blue gain on one of the monitors. After color balancing, brightness of that monitor is going to be different (e.g., reduced). At that point it may be necessary to re-balance brightness, whereas having to re-balance gamma is unlikely. Probably just a single brightness adjustment and brightness check now completes the entire matching process.

FIG. 5 illustrates a flow diagram of an embodiment of a computer monitor equalization method, generally designated 500, carried out according to the principles of the present disclosure. The method 500 starts in a step 505, and a computer system having a plurality of monitors is provided in a step 510. Then, display image samples are captured from the plurality of monitors, wherein the display image samples are captured optically for monitor equalization employing a mobile network device, in a step 515. The display image samples are analyzed to determine a monitor adjustment required to equalize the plurality of monitors, in a step 520.

In one embodiment, one of the display image samples is selected for comparison with each remaining display image sample to determine a corresponding monitor adjustment. In another embodiment, the monitor adjustment is selected from the group consisting of a brightness adjustment, a gamma adjustment and a color adjustment. In a further embodiment, the capturing and the analyzing of the display image samples are incorporated into the mobile network device. Correspondingly, the mobile network device is a mobile phone or a computer tablet.

In a yet further embodiment, the analyzing of the display image samples is provided in at least one selected from the group consisting of a computer system, a handheld device, an Internet server and a cloud server. In a still further embodiment, the display image samples are provided to the computer system having the plurality of monitors to determine the monitor adjustment required to equalize the plurality of monitors. Correspondingly, the display image samples are provided to the computer system using at least one selected from the group consisting of a WiFi system, an Internet system and a cloud system.

In still a further embodiment, the monitor adjustment required to equalize the plurality of monitors is selected from the group consisting of a VCP command supported adjustment and a GPU based adjustment. In yet a further embodiment, the capturing of the display image samples is provided by a standalone digital camera having an image transfer connection to the computer system, which then analyzes the display image samples to provide the monitor adjustment required to equalize the plurality of monitors. The method 500 ends in a step 525.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A computer monitor equalization system, comprising:
a computer system having a plurality of monitors;
a mobile networking unit that captures display image samples from the plurality of monitors, wherein the display image samples are captured optically for monitor equalization;
an image analyzing unit that analyzes the display image samples to determine a monitor adjustment required to equalize the plurality of monitors.

2. The system as recited in claim 1 wherein one of the display image samples is selected for comparison with each remaining display image sample to determine a corresponding monitor adjustment.

3. The system as recited in claim 1 wherein the monitor adjustment is selected from the group consisting of:
a brightness adjustment;
a gamma adjustment; and
a color adjustment.

4. The system as recited in claim 1 wherein the mobile networking unit is a handheld device that incorporates the image analyzing unit.

5. The system as recited in claim 1 wherein the mobile networking unit is a mobile phone or a computer tablet.

6. The system as recited in claim 1 wherein the image analyzing unit is contained in at least one of the group consisting of:
a computer system;
a handheld device;
an Internet server; and
a cloud server.

7. The system as recited in claim 1 wherein the mobile networking unit provides the display image samples to the computer system having the plurality of monitors to determine the monitor adjustment required to equalize the plurality of monitors.

8. The system as recited in claim 7 wherein the display image samples are provided to the computer system using at least one selected from the group consisting of:
a WiFi system;
an Internet system; and
a cloud system.

9. The system as recited in claim 1 wherein the monitor adjustment required to equalize the plurality of monitors is selected from the group consisting of:
a VCP command supported monitor adjustment; and
a GPU based adjustment.

10. The system as recited in claim 1 wherein the mobile networking unit is a standalone digital camera having a network image transfer connection to the computer system.

11. A computer monitor equalization method, comprising:
providing a computer system having a plurality of monitors;
capturing display image samples from the plurality of monitors, wherein the display image samples are captured optically for monitor equalization employing a mobile network device; and
analyzing the display image samples to determine a monitor adjustment required to equalize the plurality of monitors.

12. The method as recited in claim 11 wherein one of the display image samples is selected for comparison with each remaining display image sample to determine a corresponding monitor adjustment.

13. The method as recited in claim 11 wherein the monitor adjustment is selected from the group consisting of:
a brightness adjustment;
a gamma adjustment; and
a color adjustment;

14. The method as recited in claim 11 wherein the capturing and the analyzing of the display image samples are incorporated into the mobile network device.

15. The method as recited in claim 11 wherein the mobile network device is a mobile phone or a computer tablet.

16. The method as recited in claim 11 wherein the analyzing of the display image samples is provided in at least one selected from the group consisting of:
a computer system;
a handheld device;
an Internet server; and
a cloud server.

17. The method as recited in claim 11 wherein the display image samples are provided to the computer system having the plurality of monitors to determine the monitor adjustment required to equalize the plurality of monitors.

18. The method as recited in claim 17 wherein the display image samples are provided to the computer system using at least one selected from the group consisting of:
a WiFi system;
an Internet system; and
a cloud system.

19. The method as recited in claim 11 wherein the monitor adjustment required to equalize the plurality of monitors is selected from the group consisting of:
a VCP command supported monitor adjustment; and
a GPU based adjustment.

20. The method as recited in claim 11 wherein the capturing of the display image samples is provided by a standalone digital camera having a network image transfer connection to the computer system, which then analyzes the display image samples to provide the monitor adjustment required to equalize the plurality of monitors.
